(19) United States
(12) Patent Application Publication
(10) Pub. No.: US 2024/0410862 A1
(43) Pub. Date: Dec. 12, 2024

(54) ENHANCED COVERAGE LOCAL IMMERSION FOR NON-DESTRUCTIVE TEST (NDT)

(71) Applicant: Evident Canada, Inc., Québec (CA)

(72) Inventors: Alain Deschênes, Montmagny (CA); Olivier Royer, Neuville (CA)

(21) Appl. No.: 18/691,251

(22) PCT Filed: Sep. 13, 2022
(86) PCT No.: PCT/CA2022/051364

§ 371 Date: Mar. 12, 2024

Related U.S. Application Data
(60) Provisional application No. 63/261,140, filed on Sep. 13, 2021.

(51) Int. Cl. G01N 29/28; G01N 29/02; G01N 29/22

(52) U.S. Cl. CPC G01N 29/28; G01N 29/02; G01N 29/223; G01N 2291/023; G01N 2291/101

(57) ABSTRACT

An acoustic test probe assembly can include a multi-layer structure at or near an interface between the acoustic test probe assembly and a test specimen. For example, a gasket or seal arrangement can be used to establish a closed couplant-filled region between a membrane formed by the multi-layer structure and the test specimen. Excess couplant can be recovered around a perimeter of the closed couplant-filled region such as using ports or other features where suction can be applied to recover couplant, such as reducing or minimizing couplant losses while providing immersion at the interface between probed.

### CLAIM OF PRIORITY

This application claims priority to U.S. Provisional Application Ser. No. 63/261,140, filed on Sep. 13, 2021, which is incorporated by reference herein in its entirety, and the benefit of priority of which is claimed herein.

### FIELD OF THE DISCLOSURE

This document pertains generally, but not by way of limitation, to non-destructive evaluation, and more particularly, to apparatus and techniques for providing acoustic inspection, such as using a fluid immersion apparatus integrated on or within a test probe assembly.

### BACKGROUND

Various inspection techniques can be used to image or otherwise analyze structures without damaging such structures. For example, one or more of x-ray inspection, eddy current inspection, or acoustic (e.g., ultrasonic) inspection can be used to obtain data for imaging of features on or within a test specimen. For example, acoustic imaging can be performed using an array of ultrasound transducer elements, such as to image a region of interest within a test specimen. Different imaging modes can be used to present received acoustic signals that have been scattered or reflected by structures on or within the test specimen. A coupling medium can be used to facilitate incoupling or outcoupling of acoustic energy at an interface between a test probe assembly and a test specimen.

### SUMMARY

Acoustic testing, such as ultrasound-based inspection, can include focusing or beamforming techniques to aid in construction of data plots or images representing a region of interest within the test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. In another approach, a Total Focusing Method (TFM) technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array. Generally, imaging is performed as a probe or structure under test are moved relative to each other. As mentioned above, to efficiently couple acoustic energy to or from a test specimen, a coupling medium such as water can be used at an interface between a test probe assembly and the test specimen.

The present inventors have recognized, among other things, that generally available fluid coupling approaches can present various challenges. To address such challenges, acoustic inspection apparatus as shown and described herein can be used, such as providing a multi-layer structure to couple energy from an acoustic transducer to a test specimen. The multi-layer structure can include an internal fluid chamber, a first material, and a second material. A closed region can be formed between the second material layer and the test specimen such as using a gasket or seal arrangement. A couplant (e.g., water) can be provided at the interface between the test probe assembly and the test specimen, such as including both supply and suction ports. In this manner, loss of couplant can be reduced or minimized. For example, the apparatus can include a chassis to support an acoustic transducer, the chassis including a couplant fluid chamber, the couplant fluid chamber for pressurization relative to an external ambient environment of the chassis and the chamber arranged for acoustic excitation by the acoustic transducer. An applicator can be included such as to apply couplant fluid at an interface where a flexible material layer can be placed in contact with a test specimen. The couplant fluid chamber can include or defines an aperture, the aperture coupling a flexible material layer to the couplant fluid chamber and isolating the couplant fluid chamber from the external ambient environment, the flexible material layer to adapt in shape to conform to a test specimen at the interface. For example, a sealed region can be formed to maintain couplant fluid applied via the applicator at the interface.

In an example, the flexible material layer can flexibly protrude beyond a plane of the aperture to conform to the test specimen, such as in response to fluid pressure being applied within the fluid chamber. The apparatus can include at least one pressurization port fluidically coupled with the couplant fluid chamber, the pressurization port defining a fluid inlet for fluidly communicating with a source of fluid pressure. Here, the apparatus can include a fluid circuit including the fluid inlet and a fluid outlet, the fluid circuit to flow a first liquid stream through the couplant fluid chamber at a first pressure. In an example, the apparatus can include a port fluidically coupled with the applicator, the port to provide fluid couplant flow to a porous medium fluidly connected to the applicator to maintain couplant fluid at the interface.

The port fluidically coupled with the applicator can be also fluidically coupled with the couplant fluid chamber, such as coupled with the fluid outlet and to provide the first liquid stream to the porous medium after the first liquid stream has exited the fluid chamber. The port fluidically coupled with the applicator can help provide fluid couplant flow to a flow limiting medium fluidly connected to the applicator to wet the interface. In an example, the apparatus can include a second material layer located between the flexible material layer and the fluid chamber, such as Aqualene™ or an elastomer. Also, the chassis can include or use a first portion sized and shaped to be removably couplable to a second portion including the fluid chamber such as for holding the flexible material layer along an edge of the fluid chamber to fluidly seal the fluid chamber. For example, the first portion can be removably couplable to the second portion via at least one of a screw, thumbscrew, a clamp, a latch, an adhesive, an insert and receptacle, or an interlocking relationship.

The chassis can also include or use a lubricating port located adjacent to the flexible material layer or the fluid chamber, the lubricating port being fluidly connected to the couplant fluid chamber. For example, the lubricating port can be located adjacent to the flexible material layer or the fluid chamber such as to provide a couplant flow to a porous material located between the first portion and the test specimen.

Each of the non-limiting examples described herein can stand on its own, or can be combined in various permutations or combinations with one or more of the other examples.

This Summary is intended to provide an overview of the subject matter of the present patent application. It is not intended to provide an exclusive or exhaustive explanation of the invention. The detailed description is included to provide further information.

### BRIEF DESCRIPTION OF THE FIGURES

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1A depicts a perspective view of an example of a test probe assembly.

FIG. 1B depicts a partial cross-sectional view of an example of a test probe assembly.

FIG. 1C depicts a partial exploded view of an example of a test probe assembly.

FIG. 2 depicts an inspection apparatus in use for NDT of a test specimen.

FIG. 3A depicts a perspective view of an example of a probe assembly.

FIG. 3B depicts and exploded view of an example of a probe assembly.

FIG. 3C depicts a partial cross sectional view showing irrigation within an example of a probe assembly.

FIG. 3D depicts another partial cross sectional view showing irrigation within an example of a probe assembly.

FIG. 4A depicts another example of an assembled probe assembly.

FIG. 4B depicts an example of an unassembled probe assembly.

FIG. 5 depicts an example of an acoustic inspection system.

FIG. 6 is a flowchart that describes a method of inspecting a test specimen.

FIG. 7 is a flowchart that further describes the method of inspecting a test specimen from FIG. 6.

### DETAILED DESCRIPTION

Non-destructive testing or non-destructive inspection (NDT/NDI) can be used to inspect a structure for quality or other characteristics. NDT analysis can be performed on objects during or after fabrication to ensure their reliability such as by monitoring for imperfections. For example, NDT can be used to identify voids, cracks, foreign materials, separation, delamination, porosities, or other imperfections in a manufactured component. Data obtained using NDT can be processed and used to determine the presence of anomalies in the structure.

Such probes, which can use ultrasonic waves, eddy currents, or other NDT techniques, can be oriented to provide a specified spatial or volumetric region of coverage and multiple probes can be used to contemporaneously inspect different regions of an object under test, such as to enhance throughput. For example, analysis can be conducted using a coupling medium (e.g., water) between a transducer and a surface of the object under test. In one approach, a test specimen can be submerged in the coupling medium during NDT. Such an approach presents the challenge of space and handling of, e.g., large test specimens, potential wear (e.g., corrosion) of machinery, and relatively large couplant consumption. In another approach, the test specimen, rather than being submerged, can be instead coated, wetted, or sprayed with the coupling medium as the test probe assembly is moved relative to the test specimen. Here, a test probe assembly can include a multi-layer structure at or near an interface between the acoustic test probe assembly and a test specimen. For example, a gasket or seal arrangement can be used to establish a couplant-filled region between a membrane formed by the multi-layer structure and the test specimen. Excess couplant can be recovered around a perimeter of the closed couplant-filled region such as using ports or other features where suction can be applied to recover couplant, such as reducing or minimizing couplant losses while providing immersion at the interface between probed.

Generally, NDT probes can be arranged on a fixture attached to a manipulator, such as a robotic arm, a gantry, or a multi-axis scanner, or manipulated by hand. A challenge can exist for fixtures having a fixed configuration, because multiple different fixtures may be needed to accommodate differing angles, sizes, thicknesses, and other dimensions of structures under test. A challenge may also be presented in inspecting a structure with a non-uniform (e.g., curved) profile. For example, such a profile may require adjustment of the position and proximity of the probes as different regions of the structure are inspected. Several passes along the length of the structure may be required to achieve the targeted inspection coverage. Also, it can be challenging to establish a couplant-filled region in a test probe assembly to mitigate a need to submerge the test specimen during NDT. For example, couplant can leak or run down the test specimen where a sealed region is inadequate, or the test specimen may need supplemental (e.g., manual) lubrication during testing, complicating the process. The present inventors have recognized, among other things, that an adaptable fixture can be used, such as to accommodate various structures to support NDT inspection while reducing a need for to submerge the test specimen during inspection.

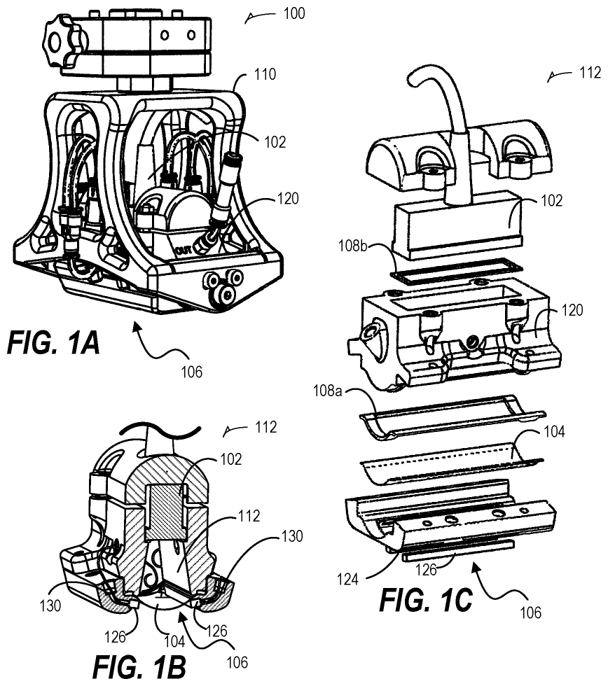

FIG. 1A, FIG. 1B, and FIG. 1C depict an example of a test probe assembly 100. The test probe assembly 100 can include a chassis 110 to support an acoustic transducer 102 and an applicator 120, and the applicator portion 120 can apply couplant at or near an interface 106 where a flexible material layer 104 can be placed in contact with a test specimen. As depicted in the partial cross section shown in FIG. 1B, the test probe assembly 100 can also include or use a couplant fluid chamber 112. Here, the couplant fluid chamber 112 can be pressurized relative to an external ambient environment of the chassis 110. Couplant fluid held within the chamber 112 can enable acoustic excitation by the acoustic transducer 102 and can help visualize or monitor the test specimen at the interface 106.

As shown in the partial exploded view in FIG. 1C, the chamber 112 can be composed of a plurality of portions separated by one or more gaskets or spacers 108. For example, the chamber 112 can define an aperture 124, the aperture 124 coupling the flexible material layer 104 to the couplant fluid chamber 112 and isolating the couplant fluid chamber 112 from the external ambient environment. Here, the flexible material layer 104 can be formed of a material such as to adapt in shape, based on a fluid pressure of couplant in the fluid chamber 112, to conform to a test specimen at the interface 106. For example, the flexible material layer can be formed of a material including at least one of polytetrafluoroethylene (PTFE), fluorinated ethylene propylene (FEP), or perfluoroalkoxy alkane (PFA), or a combination thereof. Also, the flexible material layer 104 can be formed of a material selected such that it is resistant to chemical contamination with the couplant fluid used for a test sample, such as a hydrofluoroalkoxy alkane (HFA). In general, the flexible material layer 104 can be chosen to have a stiffness that is compatible with or appropriate for the specimen test, such as to facilitate or enhance the visualization of the specimen structure at the interface 106. In some examples, the material used for the flexible material layer 104 can have a Young's modulus in the range of from about 0.01 to about 1000 MPa. For example, in some examples the Young's modulus can be from about 1 MPa to about 200 MPa. In some examples, the Young's modulus can be less than or equal to about 15 MPa, and in some examples, the Young's modulus can be less than or equal to about 10 MPa. In an example, a sealed region can be formed at or near the flexible material layer 104, including at least one sealing member such as the spacer or gasket 108a. The sealed region can help maintain couplant fluid applied via the applicator portion 120 at the interface 106. In operation and use, fluid pressure in the couplant fluid chamber 112 can cause the flexible material layer flexibly protrudes beyond a plane of the aperture 124 to conform to the test specimen at the interface 106.

Couplant fluid described herein is not limited to having acoustic couplant properties; rather, the couplant can have any acoustic property, including a non-transducer acoustic property. While the couplant fluid is referred to herein as having acoustic properties, it should be understood that the fluid has any acoustic properties such as, but not limited to, acoustic reflectance, acoustic absorption, acoustic impedance, thermal conductivity, thermal diffusivity, mechanical stiffness, mechanical damping, and combinations thereof. While the couplant fluid is referred to herein as having acoustic properties, it should be understood that the fluid has any acoustic properties such as, but not limited to, acoustic reflectance, acoustic absorption, acoustic impedance, thermal conductivity, thermal diffusivity, mechanical stiffness, mechanical damping, and combinations thereof. Accordingly, the inspection method described herein can include using any of the acoustic inspection techniques described above, such as, for example, inspection using an array of transducers or a single transducer.

In an example, as shown in FIG. 1B, the test probe assembly 100 can also include one or more ports 116 fluidically coupled with the applicator 120, the port 116 to provide fluid couplant flow to a flow limiting medium 126 fluidly connected to the applicator portion 120 to wet the test specimen at the interface 106. In an example, the port 116 can be fluidically coupled with the couplant fluid chamber 112. Alternatively or additionally, the port 116 can be fluidically coupled to a dedicated or separate chamber for supplying the coupling fluid external to the chamber 112 and at the flow limiting medium 126. The flow limiting medium 126 can act as a “waterlogged” sponge to leave a couplant residue while retaining couplant therein as the probe assembly 100 is translated with respect to the test specimen. For example, the flow limiting medium 126 can be formed of or otherwise include a porous material or absorbent material. The flow limiting medium 126 can include at least one of polyurethane foam, a knitted mesh or fabric, a micro-porous film, thermoplastic polyurethane (TPU), polyethylene, polyester, polypropylene, polytetrafluoroethylene, polyacrylonitrile, polyvinyl alcohol, cellulose, polyvinylchloride (PVC), polyvinylidene chloride (PVDC), or a combination thereof. In an example, the test probe assembly 100 can also include a second material layer located between the flexible material layer 104 and the fluid chamber 112. In an example, the second material can include an elastomer such as a silicone elastomer, a thermoplastic elastomer, a styrene elastomer, or a combination thereof. For example, the second material layer can be formed, at least in part, of Aqualene™.

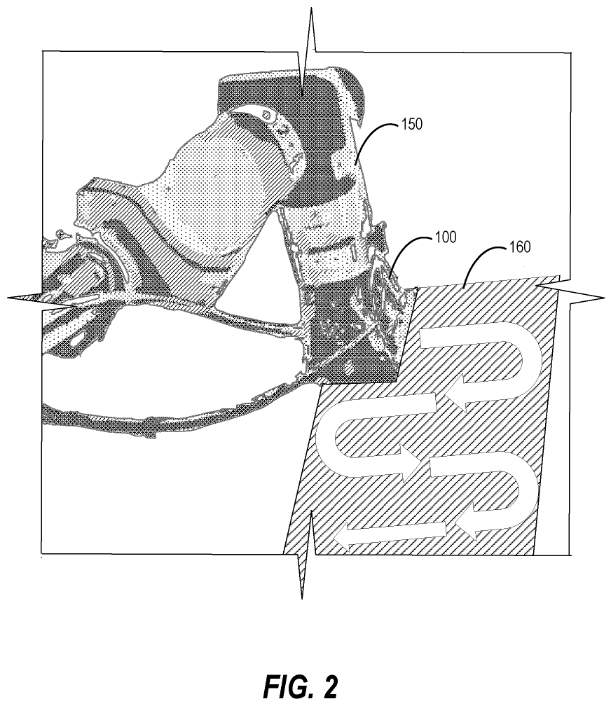

FIG. 2 depicts an inspection apparatus in use for NDT of a test specimen. In an example, the test probe assembly 100 can include or use a mechanical coupling that can be used to attach the test probe assembly 100 to a manipulator 150 such as such as a robotic arm, a gantry, a multi-axis scanner, or other device to facilitate semi-automated or automated inspection. The manipulator 150 can include a motion control system such as a robot controller, position controller, or a motion planning algorithm. As depicted in FIG. 2, the manipulator 150 can include a robot, such as a robot arm, that is configured to translate, rotate, twist, or otherwise manipulate the probe assembly 100. For instance, the manipulator 150 can position the probe assembly 100 near an inspection site on a test specimen 160. The arrangement of componentry within test probe assembly 100, as described above with respect to FIG. 1, can provide a visualization region that is nearly as large as the surface area of a face of the probe assembly 100 contacting the test specimen 160 at the interface. As such, the test probe assembly 100, when positioned via the manipulator 150, can inspect an entirety of the test specimen in a single inspection run. In an example, the manipulator 150 can move the probe assembly 100 in a serpentine pattern over the surface of the test specimen 160 to examine all areas of the test specimen 160. For instance, the manipulator 150 can translate and/or rotate the probe assembly 100 in two dimensions relative to the test specimen 160 to inspect all areas of the test specimen 160 during a single inspection run. As another example, the manipulator 150 can move the probe assembly 100 up and down relative to the test specimen 160 to inspect all areas of the test specimen 160 during a single inspection run. In an example, when the test specimen 160 includes an irregular or concave surface, the test probe assembly 100 can be rotated by the manipulator 150 to view the area around the test specimen 160 while maintaining the position of the inspection region relative to the surface of the test specimen 160. One or more linear variable differential transformers (LVDTs) can be used to provide feedback to assist in dynamic control of movement of the manipulator 150 to accommodate changes in the contour, curvature, or shape of the test object. Other sensing devices for manipulator 150 positioning can be used, such as electromechanical or optomechanical sensors.

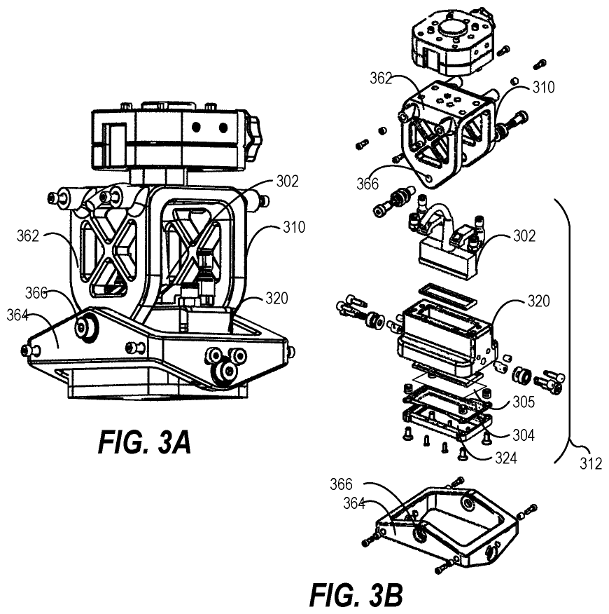

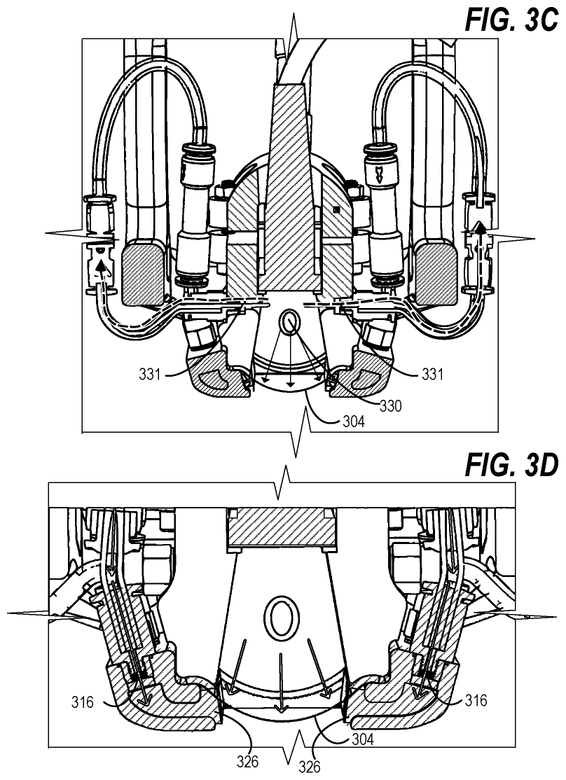

FIG. 3A, FIG. 3B, FIG. 3C, and FIG. 3D depict another example of a probe assembly. Probe assembly 300 can be similar to the probe assembly 100 described above. As such, probe assembly 300 can include or use similar components to that described above with respect to FIG. 1A-FIG. 1C and can be used in a similar manner. In an example, a probe assembly 300 can include or use at least one acoustic transducer 302 arranged within a chassis 310, and an applicator 320 to apply couplant fluid at an interface where a flexible material layer 304 can be placed in contact with a test specimen. The probe assembly 300 can also include a couplant fluid chamber 312 for pressurization relative to an external ambient environment of the chassis 310. The fluid chamber 312 can define an aperture 324 exposing a flexible material layer 304 isolating the couplant fluid chamber 312 from the external ambient environment, the flexible material layer to adapt in shape to conform to a test specimen at the interface. Also, the test probe assembly 300 can also include a second material layer 305 located between the flexible material layer 304 and the fluid chamber 312. In an example, the second material layer 305 can include an elastomer such as, e.g., Aqualene™.

As depicted in FIG. 3A and FIG. 3B, the chassis 310 can include or use a first chassis portion 362 pivotably connected to a second chassis portion 364 via a pivot point 366. In an example, the first chassis portion 362 and the second chassis portion 364 can include or use a pin and hole structure to connect them to each other, which can allow for axial and rotational movements of the chassis 310. In an example, the various components comprising the fluid chamber 312 can be coupled to the second chassis portion 364.

As depicted in the partial cross section in FIG. 3C, the test probe assembly 100 can also include one or more pressurization ports 330 fluidically coupled with the couplant fluid chamber 112, the pressurization port 330 defining a fluid inlet for fluidly communicating with a source of fluid pressure. In an example, the test probe assembly 100 can also include one or more fluid outlets 331. Couplant fluid can flow from the pressurization port 330 to the one or more fluid outlets 331 at a specified pressure. For example, the couplant chamber 112 can have fluid applied at a pressure in the range of about 0.5 bar to about 5 bar or at a pressure in the range of about 0.01 bar to about 10 bar, such as in some examples about 0.5 bar to about 4.0 bar. The viscosity of the couplant can be chosen such that when the fluid is applied via the applicator portion 120, the material layer 104 flexibly protrudes to conform to the test specimen at the interface 106. Alternatively, the fluid pressure in the couplant fluid chamber 112 can be chosen such that the material layer 104 remains relatively stationary when the fluid is applied via the applicator portion 120.

As depicted in FIG. 3D, the test probe assembly 300 can also include a one or more lubricating ports 316 fluidically coupled with the applicator 320, the one or more lubricating ports 316 to provide fluid couplant flow to help maintain couplant fluid at the interface between the probe assembly 300 and the test specimen. For example, the one or more lubricating ports 316 can be also fluidically coupled with the couplant fluid chamber 112, e.g., via a fluid connection between an individual one of the one or more fluid outlets 331 and an individual one of the one or more lubricating ports. The test probe assembly can also include or use a pressure regulator for regulating pressure of the couplant fluid chamber relative to the external ambient environment.

In an example, the fluid circuits providing couplant fluid to the one or more lubricating ports 316 or to the one or more pressurization ports 330 can be open circuits fluidly connected to an open, unpressurized reservoir holding couplant fluid. Here, the couplant fluid can be pumped or drawn through tubes, such as with an electric pump, and then supplied or recirculated back into the reservoir. This technique can enable better absorption of the transient pressure variations that occur when placing the test probe assembly on a surface of the test specimen. Also, this technique enables a wide choice of couplant fluids since the couplant fluid can be stored in a conventional, ready-to-use liquid form in a conventional container.

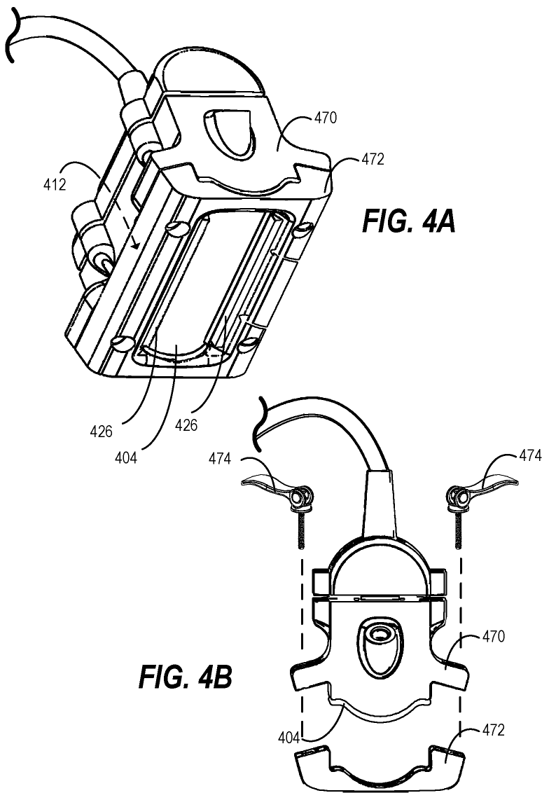

FIG. 4A and FIG. 4B depict another example of a probe assembly. Probe assembly 400 can be similar to the probe assembly 100 and probe assembly 300 described above. As such, probe assembly 400 can include or use similar components to that described above with respect to FIG. 1A-FIG. 1C and FIG. 3A-FIG. 3D, and can be used in a similar manner. A chassis 410 of the probe assembly 400 can include first portion 470 sized and shaped to be removably couplable to a second portion 472. In an example, the first portion 470 can be removably couplable to the second portion 472 via at least one of a screw, thumbscrew, a clamp, a latch, an adhesive, an insert and receptacle, and an interlocking relationship. As depicted in FIG. 4B, at least one clamping screw 474 including a cam feature can be included in the second portion 472 for clamping the first portion 470 and the second portion 472 in a coupled relationship. Also, the first portion 470, when coupled to the second portion 472, can hold the flexible material layer along an edge of a fluid chamber 412 to fluidly seal the fluid chamber 412. As used herein, the phrases “removably couplable,” “removably couple,” “removable,” “couplable,” and “couple,” can refer to components that are mechanically connected, such as capable of being inserted and removed. Such a configuration can allow for quick and easy integration or removal of the components. Also, a flow limiting medium 426 (similar to flow limiting medium 126, described above) can be included on the second, removable portion 472. In an example, the flow limiting medium 426 can be removably couplable to the second portion 472 via an adhesive or a mating feature such as a receptacle.

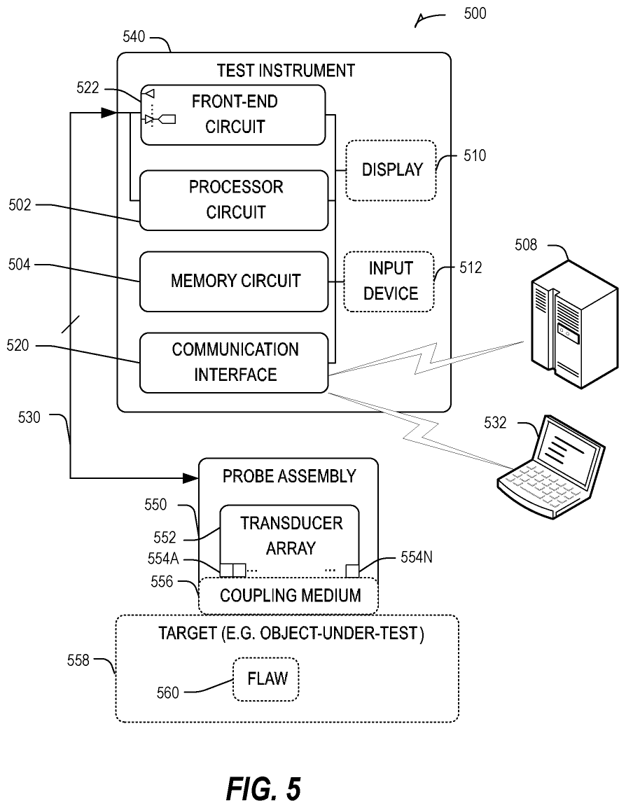

FIG. 5 illustrates generally an example comprising an acoustic inspection system 500, such as can be used to perform at least a portion one or more techniques as shown and described herein. The inspection system 500 can include a test instrument 540, such as a hand-held or portable assembly. The test instrument 540 can be electrically coupled to a probe assembly, such as using a multi-conductor interconnect 530. The probe assembly 550 can include one or more electroacoustic transducers, such as a transducer array 552 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 550 configuration can be used, such as to allow a test instrument 540 to be used with various different probe assemblies 550. Generally, the transducer array 552 includes piezoelectric transducers, such as can be acoustically coupled to a target 558 (e.g., a test specimen or “object-under-test”) through a coupling medium 556. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 556 during testing, or testing can be conducted with an interface between the probe assembly 550 and the target 558 otherwise immersed in a coupling medium. Apparatus and techniques described herein can be used to enhance coupling medium 556 coverage at the interface between the probe assembly 550 and the target 558.

The test instrument 540 can include digital and analog circuitry, such as a front-end-circuit 522 including one or more transmit signal chains, receive signal chains, or switching circuitry (e.g., transmit/receive switching circuitry). The transmit signal chain can include amplifier and filter circuitry, such as to provide transmit pulses for delivery through an interconnect 530 to a probe assembly 550 for insonification of the target 558, such as to image or otherwise detect a flaw 560 on or within the target 558 structure by receiving scattered or reflected acoustic energy elicited in response to the insonification.

While FIG. 5 shows a single probe assembly 550 and a single transducer array 552, other configurations can be used, such as multiple probe assemblies connected to a single test instrument 540, or multiple transducer arrays 552 used with a single or multiple probe assemblies 550 for pitch/catch inspection modes. Similarly, a test protocol can be performed using coordination between multiple test instruments 540, such as in response to an overall test scheme established from a master test instrument 540, or established by another remote system such as a compute facility 508 or general purpose computing device such as a laptop 532, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 522 can include one or more filters or amplifier circuits, along with an analog-to-digital conversion facility, such as to digitize echo signals received using the probe assembly 550. Digitization can be performed coherently. such as to provide multiple channels of digitized data aligned or referenced to each other in time or phase. The front-end circuit can be coupled to and controlled by one or more processor circuits, such as a processor circuit 502 included as a portion of the test instrument 540. The processor circuit can be coupled to a memory circuit, such as to execute instructions that cause the test instrument 540 to perform one or more of acoustic transmission, acoustic acquisition, processing, or storage of data relating to an acoustic inspection, or to otherwise perform techniques as shown and described herein. The test instrument 540 can be communicatively coupled to other portions of the system 500, such as using a wired or wireless communication interface 520.

For example, performance of one or more techniques as shown and described herein can be accomplished on-board the test instrument 540 or using other processing or storage facilities such as using a compute facility 508 or a general-purpose computing device such as a laptop 532, tablet, smart-phone, desktop computer, or the like. For example, processing tasks that would be undesirably slow if performed on-board the test instrument 540 or beyond the capabilities of the test instrument 540 can be performed remotely (e.g., on a separate system), such as in response to a request from the test instrument 540. Similarly, storage of imaging data or intermediate data such as A-scan matrices of time-series data or other representations of such data, for example, can be accomplished using remote facilities communicatively coupled to the test instrument 540. The test instrument can include a display 510, such as for presentation of configuration information or results, and an input device 512 such as including one or more of a keyboard, trackball, function keys or soft keys, mouse-interface, touch-screen, stylus, or the like, for receiving operator commands, configuration information, or responses to queries.

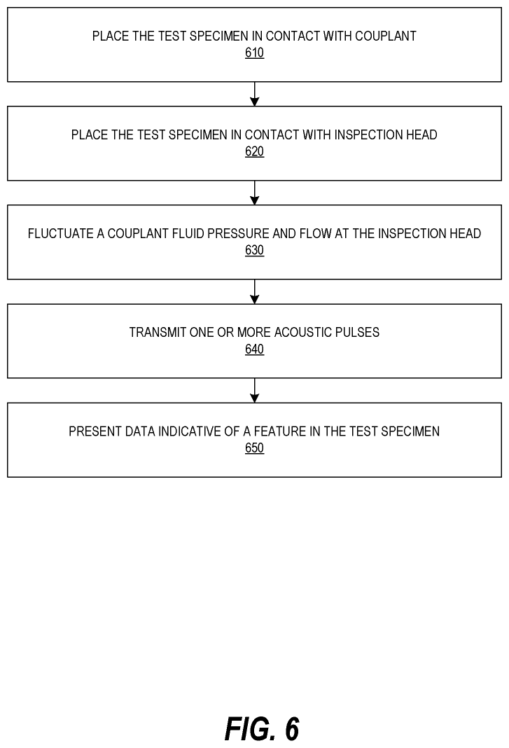

FIG. 6 is a flowchart that describes a method of inspecting a test specimen.

In an example, at 610, the method can include placing the test specimen in contact with a couplant fluid.

At 620, the method can include placing the test specimen in contact with an inspection head coupled to the inspection head including at least one acoustic transducer.

At 630, the method can include fluctuating a couplant fluid pressure and flow relative to the aperture to adapt a shape of flexible material layer to conform to a test specimen at an interface where the flexible material layer can be placed in contact with the test specimen. For example, fluctuating can include pressurizing the couplant fluid chamber such that the flexible material layer flexibly protrudes beyond a plane of the aperture in response to fluid pressure being applied within the fluid chamber to conform to the test specimen.

At 640, the method can include transmitting one or more acoustic pulses. Also, the method can include receiving acoustic echoes. For example, an acoustic signal can be transmitted or received such as using the couplant fluid in the couplant fluid chamber.

At 650, the method can include presenting data indicative of a feature in the test specimen based on characteristics of received acoustic echoes. For example, presenting data can include presenting one or more total focusing method (TFM) images or one or more full matrix capture (FMC) A-scans (amplitude time series). For example, the data can be interpreted by a user such as to identify a defect or other characteristic of the test specimen.

The couplant fluid can be also used such as to flow through couplant fluid chamber of the inspection head and the couplant fluid chamber can include or define an aperture, the aperture exposing a flexible material layer isolating the couplant fluid chamber from an external ambient environment.

The method can also include providing fluid couplant flow to a flow limiting medium to wet the interface. In an example, the method can include maintaining couplant fluid at the interface within a sealed region defined by at least one sealing member. In an example, the method can include establishing or adjusting a couplant fluid pressure and flow supplied by an applicator to the interface to apply a couplant residue to the test specimen while reducing gushing of the couplant from the interface.

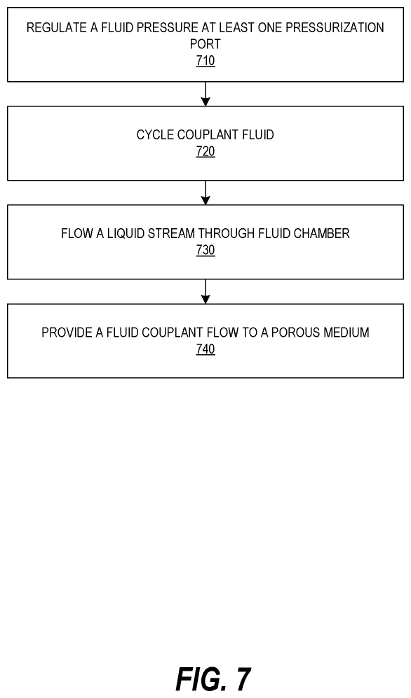

FIG. 7 is a flowchart that further describes the method of inspecting a test specimen from FIG. 6. In an example, at 710, the method can include regulating a fluid pressure at least one pressurization port fluidically coupled with the couplant fluid chamber.

In an example, at 720, the method can include cycling couplant fluid through a fluid circuit of the inspection head.

At 730, the cycling can include flowing a first liquid stream through the couplant fluid chamber.

In an example, at 740, the method can include providing a fluid couplant flow to a porous medium to maintain couplant fluid at the interface.

### NOTES AND EXAMPLES

Aspect 1 is an acoustic inspection apparatus, the apparatus including a chassis configured to support an acoustic transducer, the chassis comprising a couplant fluid chamber, the couplant fluid chamber configured for pressurization relative to an external ambient environment of the chassis and the chamber arranged for acoustic excitation by the acoustic transducer; and an applicator configured to apply couplant fluid at an interface where a flexible material layer is placed in contact with a test specimen; wherein the couplant fluid chamber comprises or defines an aperture, the aperture coupling a flexible material layer to the couplant fluid chamber and isolating the couplant fluid chamber from the external ambient environment, the flexible material layer configured to adapt in shape to conform to a test specimen at the interface.

In Aspect 2, the subject matter of Aspect 1, wherein a sealed region is formed, the sealed region defined by at least one sealing member, the sealed region configured to maintain couplant fluid applied via the applicator at the interface.

In Aspect 3, the subject matter of any of Aspects 1-2, comprising the flexible material layer; wherein the flexible material layer flexibly protrudes beyond a plane of the aperture in response to fluid pressure being applied within the fluid chamber to conform to the test specimen.

In Aspect 4, the subject matter of any of Aspects 1-3, comprising the flexible material laver; wherein the flexible material layer includes at least one of polytetrafluoroethylene (PTFE), fluorinated ethylene propylene (FEP), or perfluoroalkoxy alkane (PFA), or a combination thereof.

In Aspect 5, the subject matter of any of Aspects 1-4, comprising at least one pressurization port fluidically coupled with the couplant fluid chamber, the pressurization port defining a fluid inlet for fluidly communicating with a source of fluid pressure.

In Aspect 6, the subject matter of Aspect 5, comprising a fluid circuit including the fluid inlet and a fluid outlet, the fluid circuit configured to flow a first liquid stream through the couplant fluid chamber at a first pressure.

In Aspect 7, the subject matter of Aspect 6, comprising a port fluidically coupled with the applicator, the port to provide fluid couplant flow to a porous medium fluidly connected to the applicator to maintain couplant fluid at the interface.

In Aspect 8, the subject matter of Aspect 7, wherein the port fluidically coupled with the applicator is also fluidically coupled with the couplant fluid chamber.

In Aspect 9, the subject matter of any of Aspects 7-8, wherein the port fluidically coupled with the applicator is also fluidically coupled with the fluid outlet and configured to provide the first liquid stream to the porous medium after the first liquid stream has exited the fluid chamber.

In Aspect 10, the subject matter of any of Aspects 1-9, comprising a port fluidically coupled with the applicator, the port to provide fluid couplant flow to a flow limiting medium fluidly connected to the applicator to wet the interface, the port fluidically coupled with the couplant fluid chamber.

In Aspect 11, the subject matter of Aspect 10, comprising wherein the flow limiting medium comprises a porous material.

In Aspect 12, the subject matter of Aspect 11, wherein the porous material includes an absorbent material including at least one of polyurethane foam, a knitted mesh or fabric, a micro-porous film, thermoplastic polyurethane (TPU), polyethylene, polyester, polypropylene, polytetrafluoroethylene, polyacrylonitrile, polyvinyl alcohol, cellulose, polyvinylchloride (PVC), polyvinylidene chloride (PVDC), or a combination thereof.

In Aspect 13, the subject matter of any of Aspects 1-12, comprising a second material layer located between the flexible material layer and the fluid chamber.

In Aspect 14, the subject matter of Aspect 13, wherein the second material includes an elastomer including at least one of a silicone elastomer, a thermoplastic elastomer, a styrene elastomer, or a combination thereof.

In Aspect 15, the subject matter of Aspect 14, wherein the second material comprises Aqualene™.

In Aspect 16, the subject matter of any of Aspects 1-15, further comprising an acoustic transducer element located adjacent the fluid chamber, the acoustic transducer element configured to at least one of transmit or receive an acoustic signal using the couplant fluid in the couplant fluid chamber.

In Aspect 17, the subject matter of any of Aspects 1-16, wherein: the chassis includes a first portion sized and shaped to be removably couplable to a second portion including the fluid chamber; and the first portion, when coupled to the second portion, is configured to hold the flexible material layer along an edge of the fluid chamber to fluidly seal the fluid chamber.

In Aspect 18, the subject matter of Aspect 17, wherein the first portion is removably couplable to the second portion via at least one of a screw, thumbscrew; a clamp, a latch, an adhesive, an insert and receptacle, and an interlocking relationship.

In Aspect 19, the subject matter of any of Aspects 17-18, wherein the chassis includes a lubricating port located adjacent to the flexible material layer or the fluid chamber, the lubricating port being fluidly connected to the couplant fluid chamber.

In Aspect 20, the subject matter of any of Aspects 17-19, wherein the chassis includes a lubricating port located adjacent to the flexible material layer or the fluid chamber, the lubricating port configured to provide a couplant flow to a porous material located between the first portion and the test specimen.

Aspect 21 is a system for acoustic inspection, the system comprising: an inspection head including: at least one acoustic transducer arranged within a chassis, the chassis comprising a couplant fluid chamber, the couplant fluid chamber configured for pressurization relative to an external ambient environment of the chassis and the chamber arranged for acoustic excitation by the acoustic transducer; and an applicator configured to apply couplant fluid at an interface where a flexible material layer is placed in contact with a test specimen; wherein the couplant fluid chamber comprises or defines an aperture, the aperture exposing a flexible material layer isolating the couplant fluid chamber from the external ambient environment, the flexible material layer configured to adapt in shape to conform to a test specimen at the interface.

In Aspect 22, the subject matter of Aspect 21, wherein a sealed region is formed, the sealed region defined by at least one sealing member, the sealed region configured to maintain couplant fluid applied via the applicator at the interface.

In Aspect 23, the subject matter of any of Aspects 21-22, comprising an inspection head manipulator configured for controllably positioning the inspection head relative to a test specimen.

In Aspect 24, the subject matter of any of Aspects 21-23, wherein the inspection head comprises an integrated conveyor mechanism configured to controllably feed the test specimen through the chamber for acoustic inspection.

In Aspect 25, the subject matter of any of Aspects 21-24, comprising a pressure regulator for regulating pressure of the couplant fluid chamber relative to the external ambient environment.

In Aspect 26, the subject matter of any of Aspects 21-25, comprising the flexible material layer; wherein the flexible material layer flexibly protrudes beyond a plane of the aperture in response to fluid pressure being applied within the fluid chamber to conform to the test specimen.

In Aspect 27, the subject matter of any of Aspects 21-26, comprising at least one ultrasonic transducer, the ultrasonic transducer configured to excite the couplant fluid within the couplant fluid chamber.

In Aspect 28, the subject matter of Aspect 27, comprising at least one optical transducer, the optical transducer configured to measure acoustic excitation and/or emission of the couplant fluid within the couplant fluid chamber.

In Aspect 29, the subject matter of any of Aspects 21-28, comprising the flexible material layer; wherein the flexible material layer includes at least one of polytetrafluoroethylene (PTFE), fluorinated ethylene propylene (FEP), or perfluoroalkoxy alkane (PFA), or a combination thereof.

In Aspect 30, the subject matter of any of Aspects 21-29, comprising at least one pressurization port fluidically coupled with the couplant fluid chamber, the pressurization port defining a fluid inlet for fluidly communicating with a source of fluid pressure.

In Aspect 31, the subject matter of Aspect 30, comprising a fluid circuit including the fluid inlet and a fluid outlet, the fluid circuit configured to flow a first liquid stream through the couplant fluid chamber at a first pressure.

In Aspect 32, the subject matter of Aspect 31, comprising a port fluidically coupled with the applicator, the port to provide fluid couplant flow to a porous medium fluidly connected to the applicator to maintain couplant fluid at the interface.

In Aspect 33, the subject matter of Aspect 32, wherein the port fluidically coupled with the applicator is also fluidically coupled with the couplant fluid chamber.

In Aspect 34, the subject matter of any of Aspects 32-33, wherein the port fluidically coupled with the applicator is also fluidically coupled with the fluid outlet and configured to provide the first liquid stream to the porous medium after the first liquid stream has exited the fluid chamber.

In Aspect 35, the subject matter of any of Aspects 21-34, comprising a port fluidically coupled with the applicator, the port to provide fluid couplant flow to a flow limiting medium fluidly connected to the applicator to wet the interface, the port fluidically coupled with the couplant fluid chamber.

In Aspect 36, the subject matter of Aspect 35, comprising wherein the flow limiting medium comprises a porous material.

In Aspect 37, the subject matter of Aspect 36, wherein the porous material includes an absorbent material including at least one of polyurethane foam, a knitted mesh or fabric, a micro-porous film, thermoplastic polyurethane (TPU), polyethylene, polyester, polypropylene, polytetrafluoroethylene, polyacrylonitrile, polyvinyl alcohol, cellulose, polyvinylchloride (PVC), polyvinylidene chloride (PVDC), or a combination thereof.

In Aspect 38, the subject matter of any of Aspects 21-37, comprising a second material layer located between the flexible material layer and the fluid chamber.

In Aspect 39, the subject matter of Aspect 38, wherein the second material includes an elastomer including at least one of a silicone elastomer, a thermoplastic elastomer, a styrene elastomer, or a combination thereof.

In Aspect 40, the subject matter of Aspect 39, wherein the second material comprises Aqualene™.

In Aspect 41, the subject matter of any of Aspects 21-40, further comprising an acoustic transducer element located adjacent the fluid chamber, the acoustic transducer element configured to at least one of transmit or receive an acoustic signal using the couplant fluid in the couplant fluid chamber.

In Aspect 42, the subject matter of any of Aspects 21-41, wherein: the chassis includes a first portion sized and shaped to be removably couplable to a second portion including the fluid chamber; and the first portion, when coupled to the second portion, is configured to hold the flexible material layer along an edge of the fluid chamber to fluidly seal the fluid chamber.

In Aspect 43, the subject matter of Aspect 42, wherein the first portion is removably couplable to the second portion via at least one of a screw, thumbscrew, a clamp, a latch, an adhesive, an insert and receptacle, and an interlocking relationship.

In Aspect 44, the subject matter of any of Aspects 42-43, wherein chassis includes a lubricating port located adjacent to the flexible material layer or the fluid chamber, the lubricating port being fluidly connected to the couplant fluid chamber.

In Aspect 45, the subject matter of any of Aspects 42-44, wherein the chassis includes a lubricating port located adjacent to the flexible material layer or the fluid chamber, the lubricating port configured to provide a couplant flow to a porous material located between the first portion and the test specimen.

Aspect 46 is a method of inspecting a test specimen, the method comprising: placing the test specimen in contact with a couplant fluid; placing the test specimen in contact with an inspection head coupled to the inspection head including at least one acoustic transducer, wherein the couplant fluid is configured to flow through couplant fluid chamber of the inspection head and the couplant fluid chamber includes or defines an aperture, the aperture exposing a flexible material layer isolating the couplant fluid chamber from an external ambient environment; fluctuating a couplant fluid pressure and flow relative to the aperture to adapt a shape of flexible material layer to conform to a test specimen at an interface where the flexible material layer is placed in contact with the test specimen; transmitting one or more acoustic pulses via the acoustic transducer; receiving acoustic echoes corresponding to the one or more acoustic pulses; and presenting data indicative of a feature in the test specimen based on characteristics of the received acoustic echoes.

In Aspect 47, the subject matter of Aspect 46, comprising maintaining couplant fluid at the interface within a sealed region defined by at least one sealing member.

In Aspect 48, the subject matter of any of Aspects 46-47, comprising establishing or adjusting a couplant fluid pressure and flow supplied by an applicator to the interface to apply a couplant residue to the test specimen while reducing gushing of the couplant from the interface.

In Aspect 49, the subject matter of any of Aspects 46-48, wherein fluctuating includes pressurizing the couplant fluid chamber such that the flexible material layer flexibly protrudes beyond a plane of the aperture in response to fluid pressure being applied within the fluid chamber to conform to the test specimen.

In Aspect 50, the subject matter of any of Aspects 46-49, comprising regulating a fluid pressure at least one pressurization port fluidically coupled with the couplant fluid chamber.

In Aspect 51, the subject matter of Aspect 50, comprising cycling couplant fluid through a fluid circuit, including flowing a first liquid stream through the couplant fluid chamber at a first pressure.

In Aspect 52, the subject matter of Aspect 51, comprising providing a fluid couplant flow to a porous medium to maintain couplant fluid at the interface.

In Aspect 53, the subject matter of any of Aspects 46-52, comprising providing fluid couplant flow to a flow limiting medium to wet the interface.

In Aspect 54, the subject matter of any of Aspects 46-53, comprising transmitting or receiving an acoustic signal using the couplant fluid in the couplant fluid chamber.

Aspect 55 is at least one machine-readable medium including instructions that, when executed by processing circuitry, cause the processing circuitry to perform operations to implement of any of Aspects 1-54.

Aspect 56 is an apparatus comprising means to implement of any of Aspects 1-54.

Aspect 57 is a system to implement of any of Aspects 1-54.

Aspect 58 is a method to implement of any of Aspects 1-54.

Each of the non-limiting aspects described herein can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

1.-54. (canceled)

55. An acoustic inspection apparatus, the apparatus comprising:
a chassis configured to support an acoustic transducer, the chassis comprising a couplant fluid chamber for pressurization relative to an external ambient environment of the chassis and the chamber arranged for acoustic excitation by the acoustic transducer; and
an applicator configured to apply couplant fluid at an interface where a flexible material layer is placed in contact with a test specimen;
wherein the couplant fluid chamber comprises or defines an aperture coupling a flexible material layer to the couplant fluid chamber and isolating the couplant fluid chamber from the external ambient environment.

56. The apparatus of claim 55, wherein the flexible material layer is configured to adapt in shape to conform to a test specimen at the interface.

57. The apparatus of claim 55, wherein a sealed region is formed, the sealed region defined by at least one sealing member, the sealed region configured to maintain couplant fluid applied via the applicator at the interface.

58. The apparatus of claim 55, comprising the flexible material layer;
wherein the flexible material layer flexibly protrudes beyond a plane of the aperture in response to fluid pressure being applied within the fluid chamber to conform to the test specimen.

59. The apparatus of claim 55, comprising at least one pressurization port fluidically coupled with the couplant fluid chamber, the pressurization port defining a fluid inlet for fluidly communicating with a source of fluid pressure.

60. The apparatus of claim 59, comprising a fluid circuit including the fluid inlet and a fluid outlet, the fluid circuit configured to flow a first liquid stream through the couplant fluid chamber at a first pressure.

61. The apparatus of claim 60, comprising a port fluidically coupled with the applicator, the port to provide fluid couplant flow to a porous medium fluidly connected to the applicator to maintain couplant fluid at the interface.

62. The apparatus of claim 61, wherein the port fluidically coupled with the applicator is also fluidically coupled with the couplant fluid chamber.

63. The apparatus of claim 61, wherein the port fluidically coupled with the applicator is also fluidically coupled with the fluid outlet and configured to provide the first liquid stream to the porous medium after the first liquid stream has exited the fluid chamber.

64. The apparatus of claim 55, comprising a port fluidically coupled with the applicator, the port to provide fluid couplant flow to a porous flow limiting medium fluidly connected to the applicator to wet the interface, the port fluidically coupled with the couplant fluid chamber.

65. The apparatus of claim 55, comprising a second material layer located between the flexible material layer and the fluid chamber.

66. The apparatus of claim 55, further comprising an acoustic transducer element located adjacent the fluid chamber, the acoustic transducer element configured to at least one of transmit or receive an acoustic signal using the couplant fluid in the couplant fluid chamber.

67. The apparatus of claim 55, wherein:
the chassis includes a first portion sized and shaped to be removably couplable to a second portion including the fluid chamber; and
the first portion, when coupled to the second portion, is configured to hold the flexible material layer along an edge of the fluid chamber to fluidly seal the fluid chamber.

68. The apparatus of claim 67, wherein the chassis includes a lubricating port located adjacent to the flexible material layer or the fluid chamber, the lubricating port being fluidly connected to the couplant fluid chamber.

69. A system for acoustic inspection, the system comprising:
an inspection head including:
at least one acoustic transducer arranged within a chassis, the chassis comprising a couplant fluid chamber, the couplant fluid chamber configured for pressurization relative to an external ambient environment of the chassis and the chamber arranged for acoustic excitation by the acoustic transducer; and
an applicator configured to apply couplant fluid at an interface where a flexible material layer is placed in contact with a test specimen;
wherein the couplant fluid chamber comprises or defines an aperture, the aperture exposing a flexible material layer isolating the couplant fluid chamber from the external ambient environment, the flexible material layer configured to adapt in shape to conform to a test specimen at the interface.

70. The system of claim 69, wherein a sealed region is formed, the sealed region defined by at least one sealing member, the sealed region configured to maintain couplant fluid applied via the applicator at the interface.

71. The system of claim 69, comprising an inspection head manipulator configured for controllably positioning the inspection head relative to a test specimen.

72. A method of inspecting a test specimen, the method comprising:
placing the test specimen in contact with a couplant fluid;
placing the test specimen in contact with an inspection head coupled to the inspection head including at least one acoustic transducer, wherein the couplant fluid is configured to flow through couplant fluid chamber of the inspection head and the couplant fluid chamber includes or defines an aperture, the aperture exposing a flexible material layer isolating the couplant fluid chamber from an external ambient environment;
fluctuating a couplant fluid pressure and flow relative to the aperture to adapt a shape of flexible material layer to conform to a test specimen at an interface where the flexible material layer is placed in contact with the test specimen;
transmitting one or more acoustic pulses via the acoustic transducer;
receiving acoustic echoes corresponding to the one or more acoustic pulses; and
presenting data indicative of a feature in the test specimen based on characteristics of the received acoustic echoes.

73. The method of claim 72, comprising maintaining couplant fluid at the interface within a sealed region defined by at least one sealing member.

74. The method of claim 72, comprising establishing or adjusting a couplant fluid pressure and flow supplied by an applicator to the interface to apply a couplant residue to the test specimen while reducing gushing of the couplant from the interface.
